(19) United States
(12) Patent Application Publication
(10) Pub. No.: US 2017/0049136 A1
(43) Pub. Date: Feb. 23, 2017

(54) METHODS FOR DETERMINATION OF BIOACTIVITY, REMOVAL, OR INACTIVATION CEREAL AMYLASE TRYPSIN INHIBITORS IN CEREALS, FLOURS AND COMPLEX FOODS

(71) Applicant: Beth Israel Deaconess Medical Center, Inc., Boston, MA (US)

(72) Inventor: Detlef SCHUPPAN, Mainz (DE)

(21) Appl. No.: 15/308,397

(22) PCT Filed: Apr. 30, 2015
(86) PCT No.: PCT/US15/28535

§ 371 Date: Nov. 2, 2016

Related U.S. Application Data
(60) Provisional application No. 61/987,884, filed on May 2, 2014.

(51) Int. Cl. A23L 5/20

(52) U.S. Cl. CPC A23L 5/28; A23L 5/23; A23V 2002/00; A23Y 2220/81; A23Y 2220/71

(57) ABSTRACT

The present invention features methods of extracting amylase trypsin inhibitors (ATIs) from processed and unprocessed foodstuff, determining bioactivity of ATIs, qualifying the amount of ATIs in a foodstuff, and reducing the content of ATIs in a foodstuff.

### BACKGROUND

Ingestion of wheat, barley, or rye triggers small intestinal inflammation in patients with celiac disease. Specifically, the storage proteins of these cereals (gluten) elicit an adaptive Th1-mediated immune response in individuals carrying HLA-DQ2 or HLA-DQ8 as a major genetic predisposition. This well-defined role of adaptive immunity contrasts with an ill defined component of innate immunity in celiac disease. We have identified the alpha-amylase/trypsin inhibitors (ATIs) CM3 and 0.19, pest resistance molecules in wheat, as strong activators of innate immune responses in monocytes, macrophages, and dendritic cells. ATIs engage the TLR4-MD2-CD14 complex and lead to up-regulation of maturation markers. ATIs then elicit release of proinflammatory cytokines from cells inceliac and non-celiac patients. Mice deficient in TLR4 or TLR4 signaling are protected from intestinal and systemic immune responses upon oral challenge with ATIs. These findings define cereal ATIs as contributors to celiac disease. Moreover, ATIs may fuel inflammation and immune reactions in other intestinal and non-intestinal immune disorders. There exists a need for novel technologies and methods that are able to remove ATI from foods.

### SUMMARY OF THE INVENTION

The present invention features methods of extracting ATIs from processed and unprocessed foodstuff, determining bioactivity of ATIs, qualifying the amount of ATIs in a foodstuff, and reducing the content of ATIs in a foodstuff.

In a first aspect, the invention features a method of extracting amylase trypsin inhibitors (ATIs) from a foodstuff. The method includes the steps of A) incubating the foodstuff with an extraction buffer in a mixture, B) centrifuging the mixture to form a pellet and supernatant, C) drying the supernatant, and D) reconstituting the dried supernatant in a reconstitution buffer. The extracted ATIs are present in the reconstitution buffer.

In one embodiment, the foodstuff is unprocessed prior to extraction.

In another embodiment, the foodstuff is a processed foodstuff.

In one embodiment, prior to incubating the foodstuff with an extraction buffer in a mixture, the foodstuff is ground.

In one embodiment, prior to incubating the foodstuff with an extraction buffer in a mixture, the foodstuff is defatted. Particularly, the defatting is performed by the incubation of the foodstuff with methanol/diethylether (e.g., at a 1:1 ratio).

In one embodiment, the extraction buffer is ammonium bicarbonate, chloroform/methanol, or an acid (e.g., acetic acid).

In one embodiment, the extraction buffer is at a concentration between 5 mM to 100 mM.

In one embodiment, the drying is freeze-drying.

In all of the aforementioned embodiments of the first aspect of the invention, the steps of A to C can be repeated prior to step D.

In one embodiment, the extraction buffer in steps A-C is first chloroform/methanol and the extraction buffer is ammonium bicarbonate when steps A-C are repeated. In another embodiment, the extraction buffer is ammonium bicarbonate in each repetition of steps A-C.

In one embodiment, prior to step A, the foodstuff is digested with a protease, e.g., pepsin, trypsin, chymotrypsin, and/or thermolysin).

In one embodiment, the foodstuff is first digested with pepsin followed by digestion with trypsin.

In one embodiment, after the foodstuff is digested with a protease, the foodstuff is centrifuged to form a supernatant and the supernatant is incubated with the extraction buffer of step A. Particularly, where the incubation is performed as a dialysis incubation, step B is omitted, and the extract, after dialysis, is dried in step C.

In a second aspect, the invention features a method of determining the bioactivity (in a subject having celiac disease) of ATIs in a sample. The method includes incubating ATI-reactive cells with an extract suspected of including ATIs and determining an ATI-response in the ATI-reactive cells, thereby determining the bioactivity of the ATIs in a sample.

In one embodiment, the extract suspected of including ATIs is prepared by the method of any one of the embodiments of the first aspect of the invention.

In one embodiment, the ATI-reactive cells express TLR4. Particularly, the ATI-reactive cells are selected from the group consisting of monocytes/macrophages, dendritic cells, or cells transfected with a TLR4-MD2-CD14 oligomeric signaling complex. Particularly, the cells are stable cell lines, e.g., selected from the group consisting of THP-1 and U937 cells.

In one embodiment, the determination of ATI-response includes quantification of one or more cytokines released by the cells (e.g., IL-8, IL-15, TNFα, CCL2 (MCP-1), and CCL5 (RANTES)). The quantification can be performed, e.g., by ELISA.

In all of the aforementioned embodiments of the second aspect of the invention, the cell includes a reporter gene under the control of an ATI-responsive promoter (e.g., the IL-8 promoter) and the determination of an ATI-response includes detection of expression of the reporter gene (e.g., a luminescent or fluorescent protein).

In all of the aforementioned embodiments of the second aspect of the invention, the determination of ATI-response can, e.g., include measuring a level of one or more RNAs in the cells associated with an ATI-response (e.g., Hsp27, Hsp70, and/or Hsp90).

In one embodiment, the determination of ATI-response includes detecting one or more activation markers on or in the cells (e.g., by flow-cytometry). Particularly, the one or more activation markers is selected from the group consisting of CD80, CD86, MHC class II, IL-12, IL-23, and interferon gamma (intracellular stain).

In one embodiment, the determination of ATI-response includes detecting an alteration is a signaling pathway associated with an ATI response. Particularly, the alteration in a signaling pathway is detected based on the detection of IRF-3, NFkB (p65), or NFkB nuclear translocation.

In one embodiment, the determination of ATI-response includes contacting ovalbumin or glutin specific T cells in the presence of the sample suspected of containing ATIs and measuring the proliferation of the cells.

In a third aspect of the invention, the invention features a method of quantifying the amount of ATIs in a foodstuff. The method includes: incubating the foodstuff in an extraction buffer thereby forming an extract; optionally incubating the extract with an alkalating agent; separating the ATIs from the extract; and quantifying the separated ATIs.

In one embodiment, the extraction buffer is a neutral, near neutral, or an alkaline solvent or buffer. Particularly, the extract buffer is selected from the group consisting of PBS, Tris-buffer, water, and ammonium bicarbonate.

In one embodiment, the extract buffer further includes a detergent or detergent mixture. Particularly, the detergent or detergent mixture is selected from the group consisting of sodiumdodecyl sulfate, Triton X-100, Tween-20, and sodium deoxycholate.

In one embodiment, the extraction buffer further includes a reducing agent. Particularly, the reducing agent is selected from the group consisting of mercapto-ethanol or dithioerythritol (DTT).

In one embodiment, the alkylating agent is iodoacetamide and the alkylating agent is further quenched by the addition of access reducing agent.

In one embodiment, the method further includes adding a protease (e.g., trypsin) to the extract.

In all of the aforementioned embodiments of the third aspect of the invention, the ATIs can be, e.g., quantified by mass spectrometry, quantitative western blotting, or ELISA.

In a fourth aspect of the invention, the invention features a method of reducing the reactivity of a foodstuff. The method includes cultivating a cereal with oxidized glutathione (GSSG) and/or protein bound glutathione (PSSG).

In a fifth aspect of the invention, the invention features a method of reducing the reactivity of a foodstuff. The method includes cultivating a cereal with sulfur rich or sulfur depleted fertilizers.

In a sixth aspect of the invention, the invention features a method of reducing the ATI content of a foodstuff. The method includes incubating the foodstuff in an extraction buffer for a duration sufficient to reduce the ATI content of the foodstuff by at least 50% (e.g., by any of the methods described above). This is followed by removal of the extraction buffer.

In one embodiment, the extraction buffer is a neutral, near neutral, or alkaline solvent or buffer. Particularly, the extract buffer is selected from the group consisting of PBS, Tris-buffer, water, and ammonium bicarbonate.

In one embodiment, the extract buffer further includes a detergent or detergent mixture. Particularly, the detergent or detergent mixture is selected from the group consisting of sodiumdodecyl sulfate, Triton X-100, Tween-20, and sodium deoxycholate.

In all of the aforementioned embodiments of the sixth aspect of the invention, the extraction buffer can, e.g., further include a reducing agent. Particularly, the reducing agent is selected from the group consisting of mercapto-ethanol, dithioerythritol (DTT), cysteine, or glutathione (GSH) balanced with oxidized glutathione (GSSG).

In one embodiment, the alkylating agent is iodoacetamide and the alkylating agent is further quenched by the addition of access reducing agent.

In all of the aforementioned embodiments of the sixth aspect of the invention, the foodstuff is separated mechanically prior to the incubation. Particularly, the mechanically separated foodstuff is dried prior to the incubation (e.g., by air-drying or freeze drying).

In one embodiment, prior to the drying, the mechanically separated foodstuff is contacted with an aqueous solvent or an organic solvent having a lower boiling point than water. Particularly, the organic solvent is selected from the group consisting of acetone or ethanol.

### DESCRIPTION OF THE DRAWINGS

FIG. 1 shows the induction of low grade innate inflammation in the intestine of normal mice at 12 hours after oral gavage of 100 μg of purified wheat ATIs in 200 μl PBS compared to PBS alone or 200 μg of ATI-containing gliadin (with about 20% of ATIs). Determination of inflammatory genes from the harvested intestine was performed using quantitataive RT-PCR normalized to GAPDH mRNA as housekeeping gene. ATIs caused also a mild upregulation of transglutaminase 2 (TG2) mRNA which is central to celiac disease pathogenesis. (A): Transcript levels of inflammatory markers (MCP-1=CCL2 and KC=IL-8) and of TG2 in the intestine were up-regulated after feeding a single dose of ATIs or ATI-containing gliadin (commercial product from Sigma) to C57BL/6 mice kept on a gluten-free diet. n=5 per group; *p<0.05. (B): F4-80 positive cells (macrophages, ×200) were higher in the group challenged with ATIs or ATI-containing gliadin. Macrophages show a dark colour (peroxidase-staining). Quantitative assessment counting positive cells in 4 high power fields per sample. n=5 per group.

FIG. 2 shows that an ATI containing diet exacerbates inflammatory bowel disease. Dextran sodium sulfate (DSS) colitis (Lauroui et al., PLoS One 7:e32084, 2012; Wirtz et al. Nat. Protoc. 2:541-546, 2007) was induced by adding a low dose of 1.5% DSS (w/v) in the drinking water of female C57BL/6 mice on a gluten-free diet (GFD, purely casein-based protein source) or “normal” chow containing 25% of gluten (with ˜15% w/w as AT casein as protein source. Mouse body weight changes that are strong indicators of the severity of colitis were recorded every two days (data by Dr. G. Pickert in the Ps group). Changes were significant from day 12 on (p<0.05 ATI-free vs. ATI-containing chow).

FIG. 3 shows that an ATI containing diet exacerbates experimental multiple sclerosis. (A-D): Experimental autoimmune encephalomyelitis (EAE), a suitable model of multiple sclerosis, was induced by immunization with myelin oligodendrocyte protein (MOG₃₅₋₅₅ peptide emulsified in complete Freund's adjuvant and pertussis toxin on the first day of immunization and 2 days later) in female C57BL/6 mice on a gluten-free diet (GFD, casein as protein source). Animals were divided in group 1 continuing on the GFD and group 2 changing to a diet containing 25% of gluten (with ˜15% w/w as ATIs)/75% casein as protein source). CNS-infiltrating total T cell (A), CD4+ (B) and CD8+ (C) T cell numbers were calculated using FACS-analysis of extracted brain tissue (shown is a representative experiment of three independent experiments with n=4 mice per group). Mice were observed and scored daily for clinical signs of EAE after induction (days post induction, DPI) (D). Data are representative of three independent experiments (n=10 per group, maximal clinical score 3.75). *p<0.05 comparing both groups. (E): EAE-induction in female C57BL/6 mice on a gluten-free diet (GFD) as in FIG. 3A. Animals were divided in four groups: group 1 continued with the GFD (GF to GF), group 2 changed to a diet containing purified ATIs (GF to ATI; casein-based protein source with 1% purified ATIs), group 3 changed to a diet containing 25% gluten (˜15% w/w as ATIs) (GF to G), and group 4 changed to a diet containing 25% gluten with partial de-enrichment ATIs by extraction (reduction of ATI-content by ˜70% (GF to G-ATI). Mice were observed and scored daily for clinical signs of EAE after induction (days post induction, DPI) (D). Data represents one independent experiment (n=10 per group, maximal clinical score: 2.5: incipient hindleg paralysis, see below). *p<0.05 for the area under curve from baseline to peak of disease for GF/GF vs GF/ATI. Clinical EAE score: 0, no disease; 1, decreased tail tone; 2, abnormal gait (ataxia) and/or impaired righting reflex (hind limb weakness or partial paralysis); 3, partial hind limb paralysis; 4, complete hind limb paralysis; 5, hind limb paralysis with partial fore limp paralysis; 6, moribund or dead.

FIG. 4 shows that an ATI containing diet exacerbates allergic asthma. (A-F): Murine asthma model induced by ovalbumine (OVA) sensitisations and challenge in female C57BL/6 mice on a gluten-free diet (GFD, casein as protein source) or “normal” chow containing 25% of gluten (with ˜15% w/w as ATIs)/75% casein as protein source). Serum was analysed after the sensitisations (A). Animals were sacrificed after three challenges with PBS or OVA. Bronchoalveolar lavage fluid (BALF) was used to prepare cytospins and count cell populations (B). BALF was also used to measure IL-13 and IL-5 secretion (C and D). Histological lung sections were scored after H&E and PAS staining (E and F). (G-I): Murine asthma model induced by OVA sensitisations and challenge in female C57BL/6 mice on a gluten-free diet (GFD), as detailed in FIG. 4A. Animals were divided in 5 groups: group 1 continued with the GFD and was sensitised with PBS, group 2 continued with the GFD and was sensitised with OVA, group 3 changed to a diet containing 25% gluten (with ˜15% w/w as ATIs)/75% casein as protein source), group 4 changed to a diet containing ATIs (casein-based protein source with 1% purified ATIs), and group 5 changed to a diet containing 25% gluten with low levels of ATIs (de-enriched of ATIs by ˜70%). All groups were challenged with OVA and then sacrificed. Splenocytes were isolated from each group and stimulated with 3 μg/mL of OVA for proliferation assays (A). Supernatants were analysed for cytokines IL-13 and IL-5 (B and C). **p<0.01, ***p<0.005.

FIG. 5 shows simple method to extract ATIs from wheat (rye, barley) flour, their related products, and from other plant flours for determination of bioactivity. Improved buffered solutions contain low-intermediate concentrations of salt (preferably NaCl). Examples are phosphate buffered saline, pH 7.4, or 5-50 mM ammonium bicarbonate (Abic). Other concentrations of these chemicals in the solvents or related or unrelated chemicals with buffering properties can be used, such as EDTA, EGTA, other phosphate buffers, etc. Dialysis of the extracts can be done against water, Abic solutions or acetic acid (AA). Compared to AA, Abic dialysis yields a higher ATI bioactivity in the cellular readout system.

FIG. 6 shows extraction and bioactivity determination of ATIs from flours and baked foods; complete ATI inactivation by reduction and alkylation at elevated temperature; and ATI content is low or negligible in gluten free foods. (A and B) Total protein extracted sequentially from 10 g of flour from modern wheat and form more ancient wheat variants (Iran, Kamut) AA: 0.05% acetic acid; Abic, 50 mM ammonium bicarbonate buffer. Bioactivity assay using the human monocyte-macrophage cell line THP-1 and standardized lyophoilized extracts (combined 1^{st} and 2^{nd} extract representing >90% of total ATIs). (C, D, and E) Cytokine release (IL-8 and TNF-α) after stimulation of THP-1 cells with normalized ATI-extracts from different grains and products. Dried white bread and pasta were pulverized and extracted using pepsin and trypsin containing buffers. The dialysed and lyophilised extracts were standardized and used in the bioassay. Notably, there is no significant loss of bioactivity after baking or boiling (D). (F) Reduction/alkylation (R/A) with dithiothreitol/iodoacetamide at 50° C. on enriched ATIs from spring wheat indicates complete reductive inactivation of ATI bioactivity. Lipopolysaccharide (LPS) is used as a positive control.

FIG. 7 shows other high sensitivity bioassays for bioactivity quantification of extracted ATIs. ATI extracts with Abic were lyophilized and standardized as to protein content. Dose dependent stimulatory response in (A) murine bone marrow-derived dendritic cells (BM DCs) and (B) a TLR4/MD-2/CD14/IL-8 Prom/LUCPoter™ HeLa cell line. Compared with the THP-1 cells used in FIG. 6, these readout cells showed higher sensitivity for ATI-bioactivity (ceiling effect for the luciferase system).

FIG. 8 shows summary ATI bioactivity determinations from flours and baked foods. ATI content is low or negligible in gluten free foods. Classification of grains and food products according to the amount of bioactive ATI (innate stimulating activity as determined by one of the bioassays).

FIG. 9 shows ATIs in extracts from wheat flour on SDS PAGE gels (4-20% gradient). (A) Spring wheat extracted with acetic acid (AA) and subject to salting out using different concentrations of sodium chloride (NaCl). ATIs represent most of the band running in the 10-15 kD range. Supernatant (s) and pellet (p) were treated with a without a reducing agent (dithiothreitol, dtt). Notably, in the acidic range ATIs are prominently precipitating between at 0.2 M NaCl, while at 0.5M NaCl gluten will precipitate (bands above the 25 kD range). (B) Three different wheat samples extracted with ammonium bicarbonate (Abic) with or without reducing agent. Abic mostly extracts ATIs, with only minor amounts of gluten and other proteins.

FIG. 10 shows determination of total ATI-quantity and ATI-species in different wheat extracts using mass spectrometry and relative amount of main ATIs in different extracts as well as other ATIs that include chymotrypsin inhibitor WCI, endogenous alpha-amylase/subtilisin inhibitor and CMX1/CMX3.

FIG. 11 shows relative quantity of ATI-species in different wheat extracts using mass spectrometry: (A) Abic extract, (B) chloroform/methanol (CM) extract, (C) commercial extract (1520), and (D) commercial extract (3535). Lyophilized ATI-extracts (Abic and chloroform-methanol) were reduced/alkylated, digested with trypsin and subjected to mass spectrometry.

FIG. 12 shows relative quantity of the major ATI-species CM3 and 0.19 in different wheat extracts using mass spectrometry and Western blotting. (A and B) Determination of the percentage of CM3 and 0.19 relative to total protein in commercial extract 1520 and 3535 using mass spectrometry. (C) Reducing SDS PAGE gel (4-20% gradient) and Western-blotting using rabbit peptide antibodies specific for CM3 and 0.19, respectively.

FIG. 13 shows ATI bioactivity of fermented wheat dough. (A): ATI bioactivity in 90% wheat dough fermented with 10% rye malt. Samples were extracted with Abic, lyophilized and reconstituted. Standardized extracts were cultured with the human monocytic cell line THP-1 and cytokines secreted (IL-8, MCP-1 and TNF-α) measured by ELISA. Bars in represent samples fermented with different strains (Lactobacillus sanfranciscensis (mutant), L. Sakei, L. Reuteri and L. Sanfranciscensis). Other bars represent a control sample of unfermented rye malt. Results are from 3-5 samples, and analysed for sugnificance using one way ANOVA and compared against the unfermented sample (control) using Dunnett's test. Level of significance (p<0.05) was represented by asterisks. *p<0.05, **p<0.01, ***p<0.005. (B): ATI bioactivity of fermented dough prepared with 100% whole wheat. Samples were extracted with Abic and analyzed as described above (FIG. 13A).

FIG. 14 shows inhibition of ATI-bioactivity using the natural TLR4-antagonist LPS-RS. TLR4-inhibitory lipopolysaccharide from Rhodobacter sphaeroides (LPS-RS, 1.5 μg/mL) was pre-incubated with THP-1 cells for 30 min, then ATIs enriched in CM3 and 0.19 (37.5 μg/mL) were added and cultured overnight. E. coli LPS (12.5 ng/mL) was also cultured overnight with THP-1 cells pre incubated (30 min) with LPS-RS (250 ng/mL). E. coli LPS (12.5 ng/mL), LPS-RS (1.5 μg/mL) or buffer alone served as controls.

### DETAILED DESCRIPTION OF THE INVENTION

### Amylase Trypsin Inhibitors (ATIs)

Amylase trypsin inhibitors (ATIs) (as a term for all structurally and especially functionally related molecules) are molecules present in plants that act as triggers of innate immune activation. ATIs affect not only celiac disease activity but other inflammatory conditions.

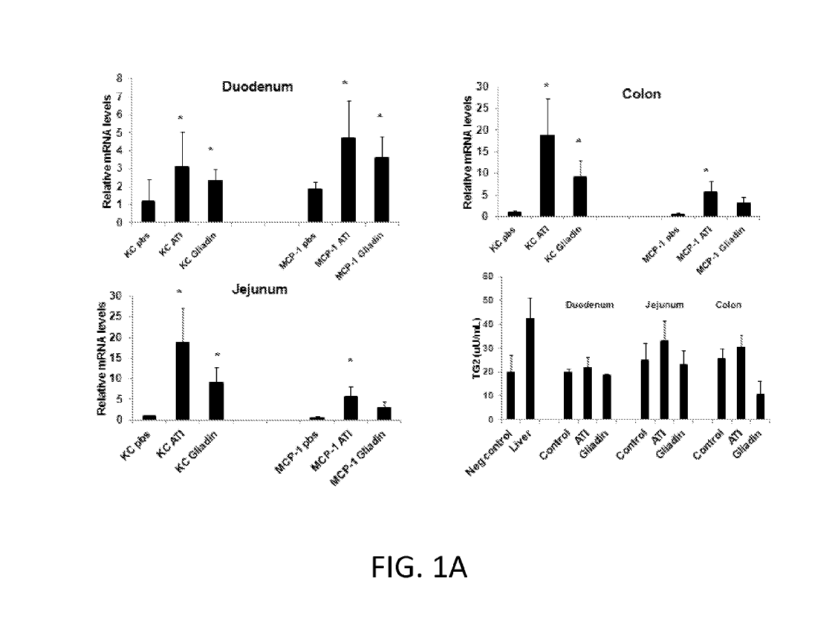

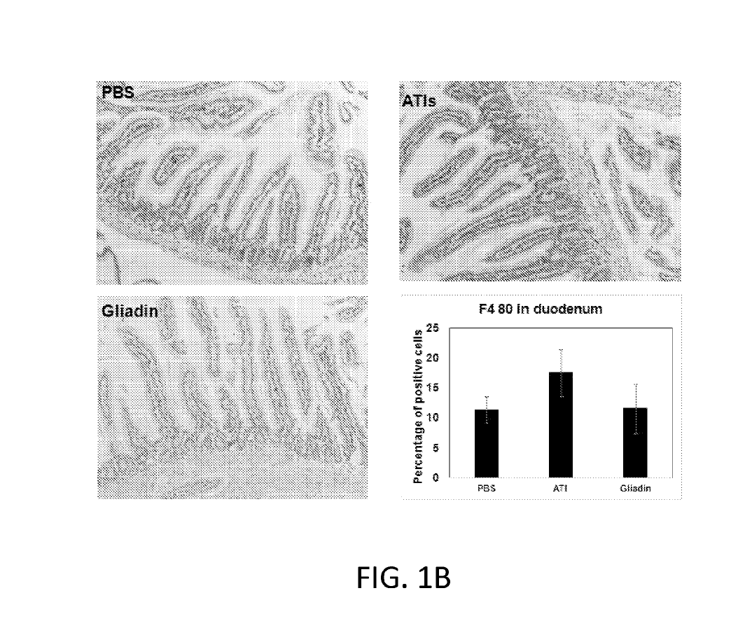

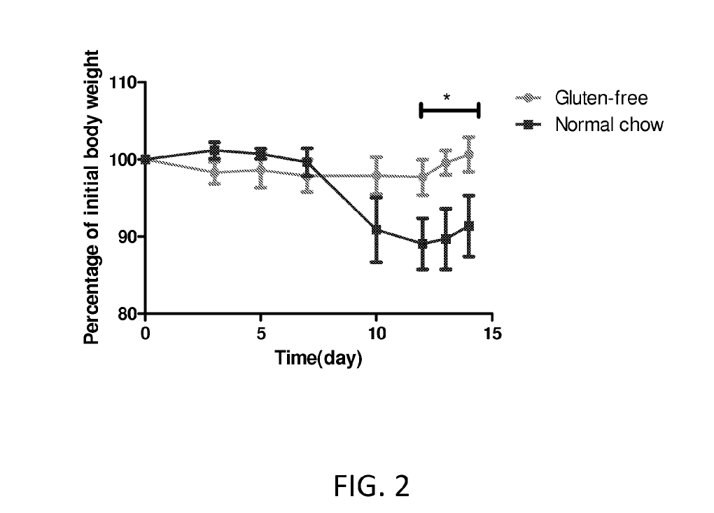

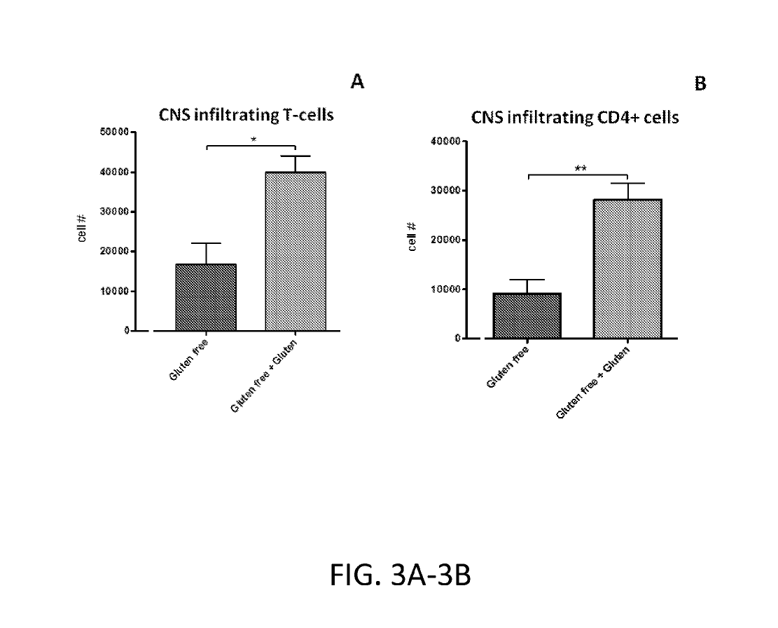

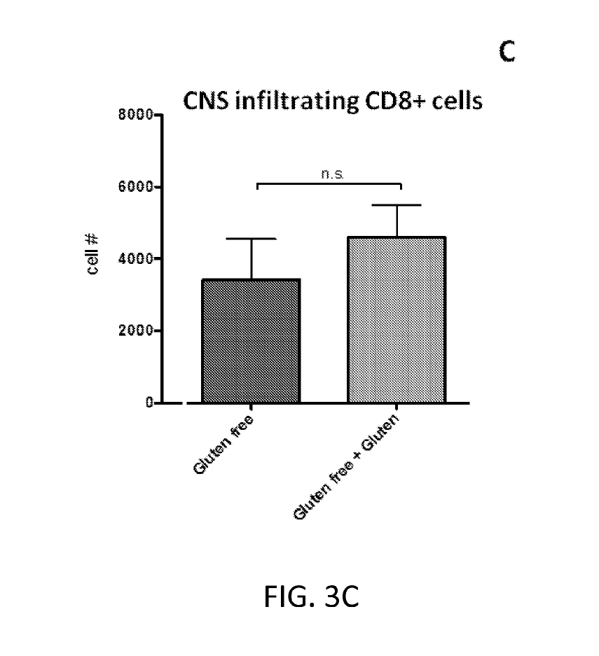

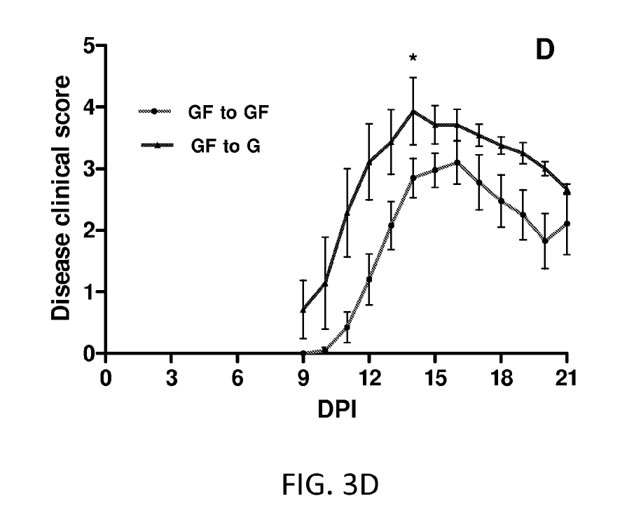

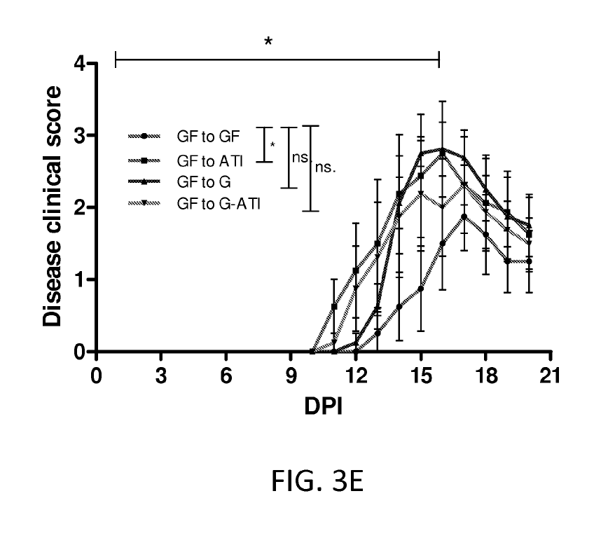

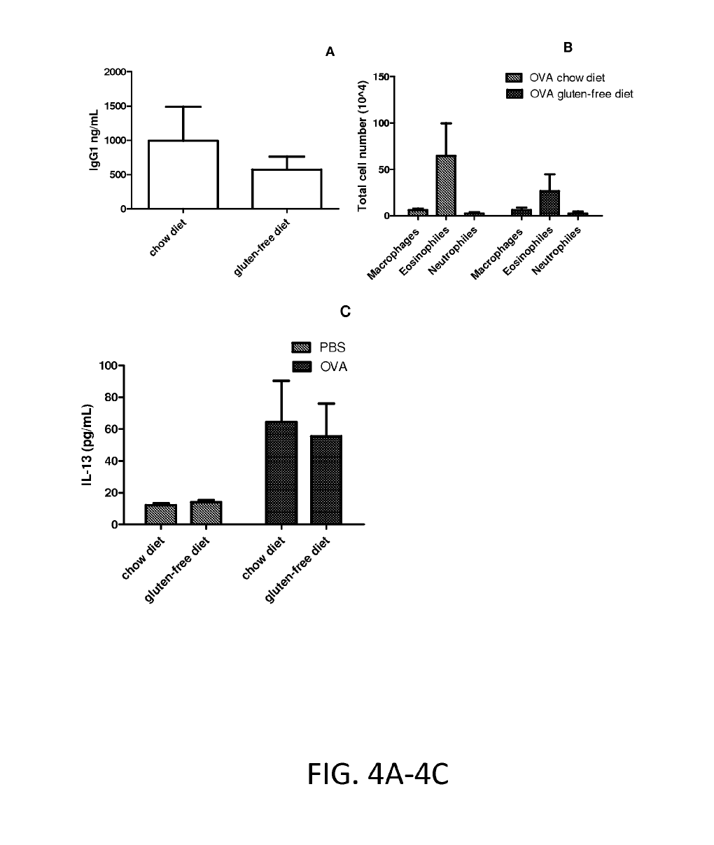

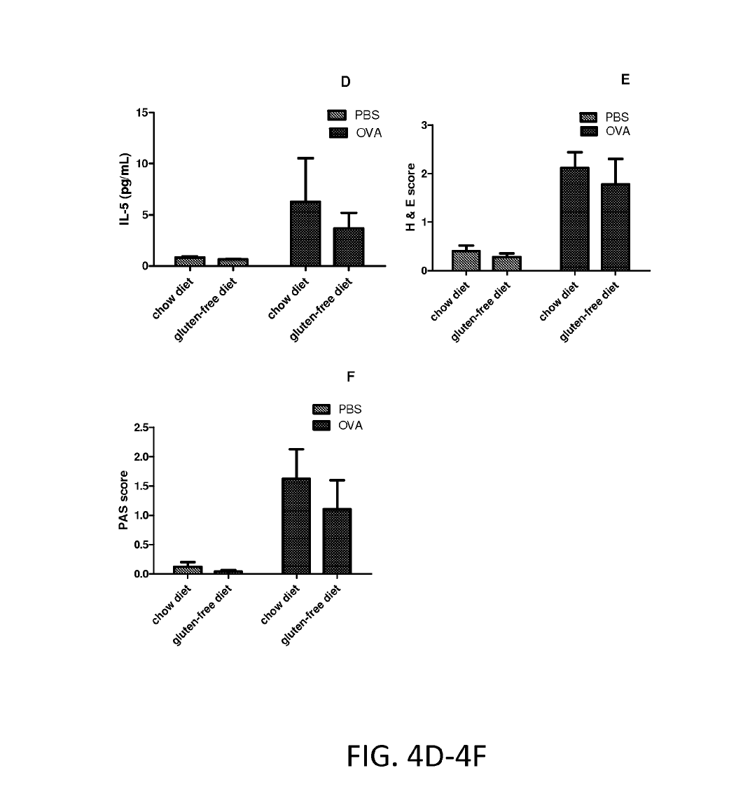

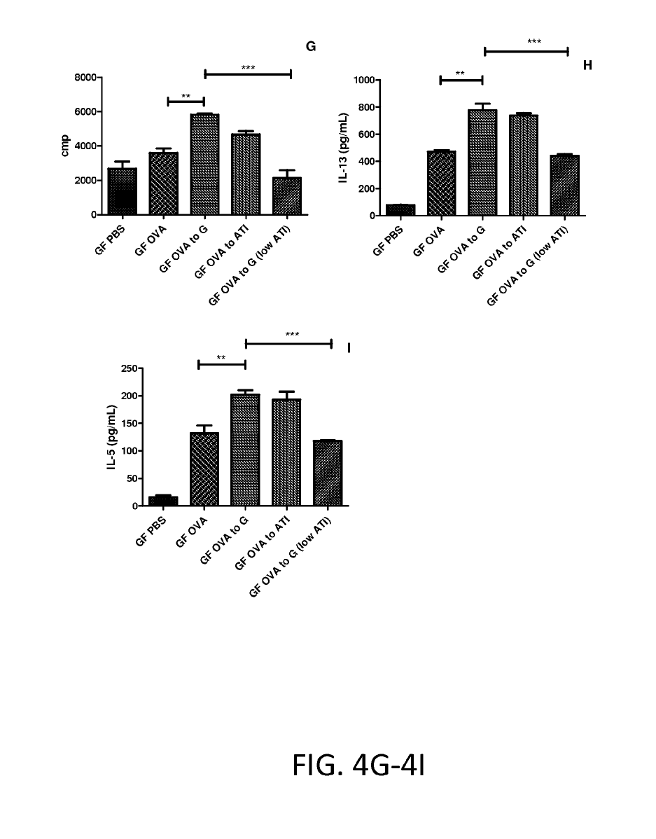

The newly discovered activity of ATIs as nutritional activators of TLR4 is different from that of gluten in celiac disease and of wheat (rye, barley) proteins in allergy. ATIs can also act as inhalative allergens (Schuppan et al, Gastroenterology 2009; Batais et al, Eur Ann Allergy Clinic 2008; Catassi et al, Nutrients 2013; Uvackova et al, J Proteome Res 2013). Notably, the disease causing potency of ATIs ingested with wheat, barley, or rye (gluten-containing cereals) is not limited to the gastrointestinal tract, but is also likely implicated to affect other extraintestinal diseases (Tilg et al, Gastroenterology 2013). We have accumulated broad evidence that nutritional ATIs induce low grade but significant inflammation in the small intestine and colon. Notably, nutritional ATIs exacerbate inflammatory diseases in general, as shown in mouse models of inflammatory bowel disease, of multiple sclerosis, and of allergic asthma. FIGS. 1-4 demonstrate this “adjuvant effect” in the mentioned in vivo situations and diseases.

The methods of the invention can be performed in a variety of foodstuffs suspected of containing ATIs, including any food stuff having a cereal grain component (e.g., baked goods as described herein).

### EXAMPLES

### Example 1

### Methods to Determine the (Proinflammatory) Bioactivity Due to ATIs in Unprocessed and Processed Foods

### 1.1. Quantitative Extraction of ATIs and Proteolytic Digestion of ATIs

Quantitative ATI Extraction from Different Cereals, Grains, and Foods for Determination of Bioactivity

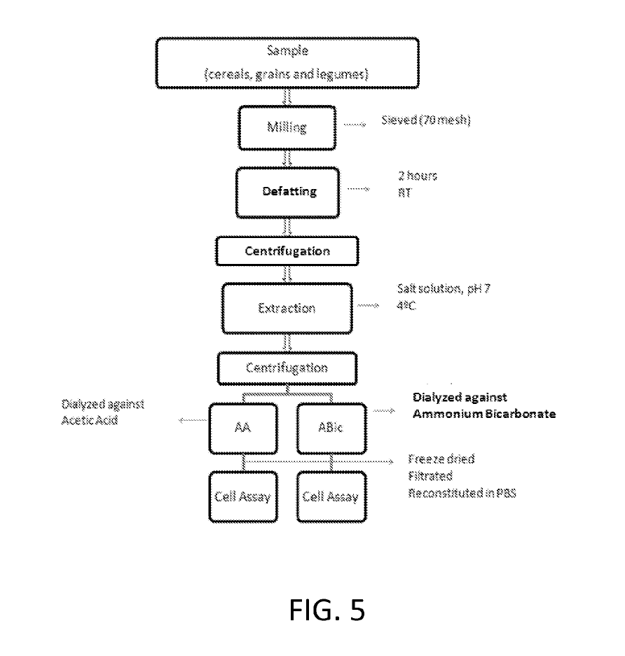

Buffer/solvent extractive method (applicable to most unprocessed foods, see sketch in FIG. 5):
1. Dried material is ground and sieved
2. 20 g are defatted with 200 ml methanol/diethylether 1:1 for 2 h at 4-8° C. (stirring)
3. Centrifugation at 5.000-10.000 rpm for 10-30 min

Steps 2.-3 can also be omitted, without significant loss of bioactivity
4. Pellet is extracted with 200 ml of 50 mM ammonium bicarbonate (Abic) overnight at 4° C. (stirring)
5. Centrifugation at 5.000-10.000 rpm for 10-30 min
6. Supernatant is freeze dried
7. Second (third) extraction as above
8. Combined supernatant is freeze-dried
9. Freeze dried material is reconstituted in e.g. 2 ml of PBS or cell culture compatible buffer or media

Other solvents such as chloroform/methanol (CM) can also be used, but they predominantly extract the more hydrophobic CM-class of ATIs, leaving other ATI species largely not extracted. Sequential extraction using CM and the above solvents/buffers or vice versa is possible.

Buffers may vary in composition. Thus ammonium bicarbonate can also may be used in lower (e.g., 5 mM) or higher (e.g., 100 mM) concentrations, other neutral or slightly alkaline buffers can be used. Even acidic extraction is possible, e.g., by using 50 mM acetic acid. However acidic buffers co-extract significant amounts of other proteins such as gluten (further described in detail below).

Quantitative ATI Extraction from Further Processed, e.g. Cooked or Baked Foods Such as Bread, Cookies, Pasta or Pizza
1. Dried material is ground and sieved
2. 20 g are defatted with 200 ml methanol/diethylether 1:1 for 2 h at 4-8° C. (stirring)
3. Centrifugation at 5.000-10.000 rpm for 10-30 min
Steps 2-3 can also be omitted, without significant loss of bioactivity
4. Pellet is digested with (gastrointestinal) proteases that do not significantly degrade the highly disulfide linked ATIs, such as pepsin followed by trypsin to better extract ATIs from the food matrix.

Proteolytic Digestion of ATIs

Example of proteolytic digestion (pepsin-trypsin digestion protocol) can be found in Frazer et al, Lancet 1959. A brief example is described below.
1. 1 g of suspended sample is digested with pepsin (10 mg in 0.5 mL of 0.1 M HCL, pH 1.8) at 37° C. for 4 h.
2. Sample is centrifuged at 4,500 rpm for 10 min and the pellet is discarded.
3. Supernatant's pH is adjusted from 1.8 to 7.8 with NaOH and then trypsin (Sigma T9201, 10 mg in 0.5 mL neutral buffer, such as PBS) is added and incubated at 37° C. for 4 h.
4. pH is adjusted to 4.5 with HCl and N-tosyl-chloromethyl-ketone (TLCK, 10 mg in 0.5 mL DMSO) is added to block the trypsin.
5. Precipitate is removed by centrifugation at 4,500 rpm for 10 min.
6. Pellet is discarded and supernatant is dialysed (molecular weight exclusion e.g. 1000 D) in 10 mM ammonium bicarbonate, Ph 7.8 (4 L, 2 changes) at 4° C.
7. Samples are sterile filtrated and freeze-dried.
8. Protein concentration may be determined by using a bicinchoninic acid protein assay (Pierce).
9. Freeze dried material is reconstituted in e.g. 2 ml of PBS or cell culture compatible buffer or media.

Other buffers and buffer and enzyme concentrations can be used, as long as enzyme activity is maintained. In some, e.g., hardly baked, foods, more harsh conditions may be applicable. Also other enzymes such as chymotrypsin or thermolysin can be used exclusively (as neutral protease) or in combination with trypsin, since these can leave ATIs largely intact, while degrading other, major (cereal) proteins such as gluten (Camus and Laporte, Reprod Nutr Dev 1980; Gessendorfer et al, Anal Bioanal Chem 2009; Jos et al, Scand J Gastroenterol 1975; Rombouts et al, Sci Rep 2013).

Due to their resistance to gastrointestinal proteases, ATIs remain largely intact after these proteolytic extraction procedures and maintain bioactivity. Our in vitro studies show that even with purified ATIs, the above-described digestion procedure reduces bioactivity by maximally 40%. Moreover, extracted bioactivity of 1 g of wheat flour before baking (10-20 min at 150-180° C.) is reduced by maximally 50% post baking.

### 1.2 Bioactivity Assays

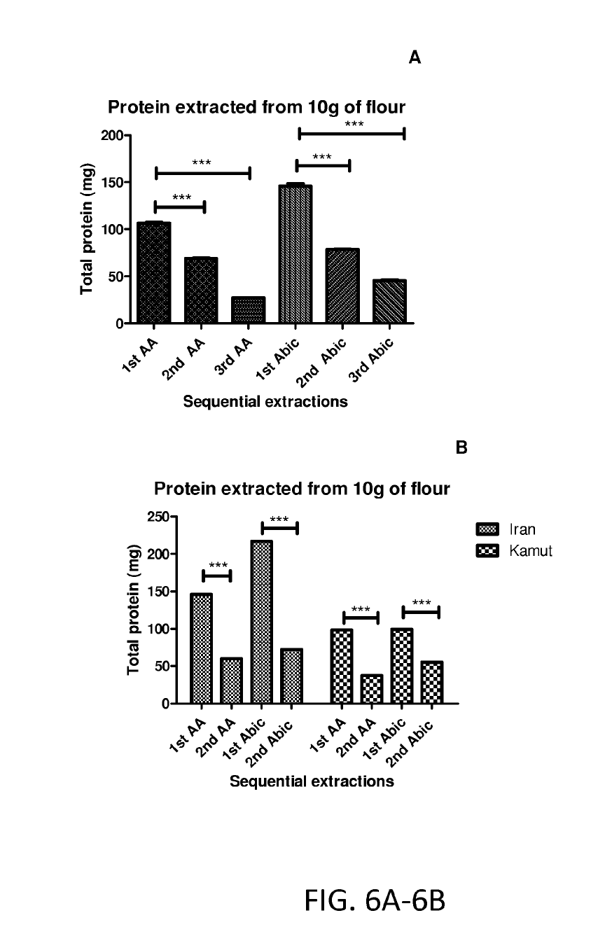

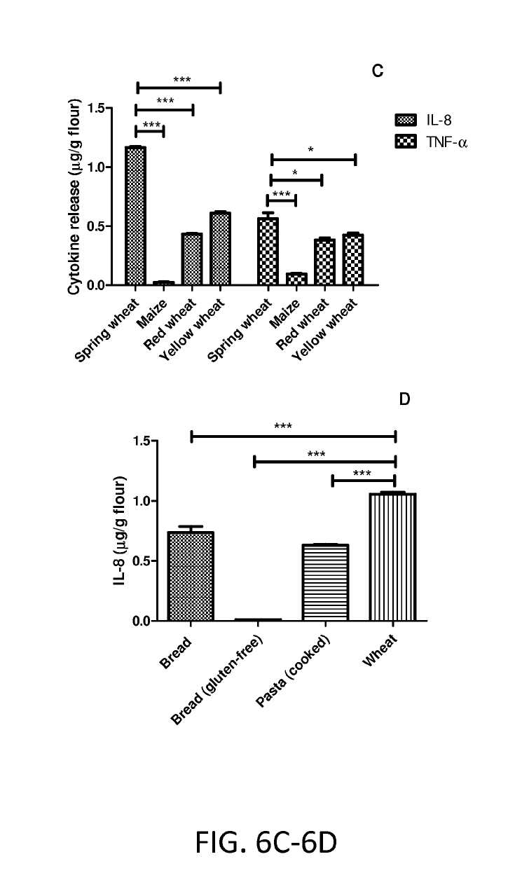

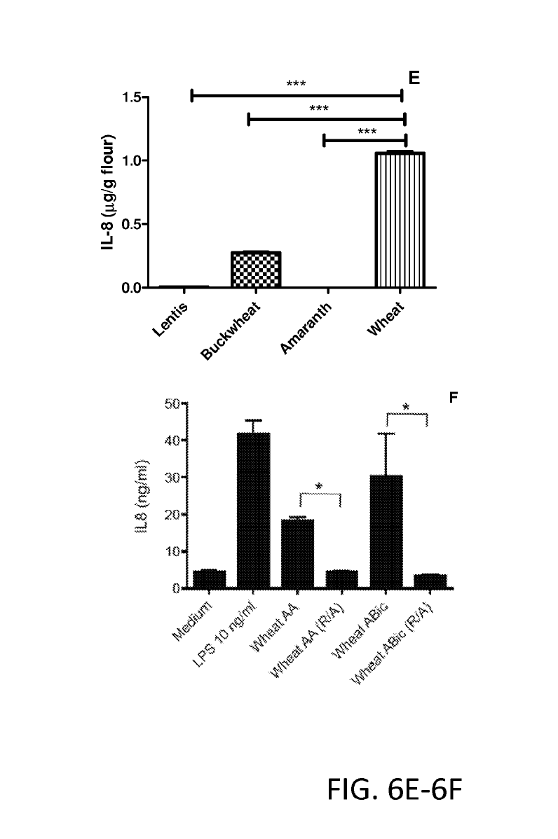

Examples of bioactivity determinations are shown in FIGS. 6-8.

### Cell Culture

ATI extracts (freeze dried or centrifuged/concentrated) as described in Example 1 and reconstituted in cell-culture compatible buffers, are added to cultures of ATI-reactive (TLR4-bearing) cells, preferably monocytes/macrophages, dendritic cells, or cells transfected with the TLR4-MD2-CD14 oligomeric signaling complex. It is also preferable to use stable cell lines such as human THP-1, U937, or TLR4-MD2-CD14 transfected HEK-293 cells (obtainable e.g. from American Type Culture Collection). Apart from human cells, cells of other species such as mouse or rat can be used. Culture is preferably in complete RPMI or DMEM supplemented with 100 IU/ml penicillin/100 μg/ml streptomycin and 10% fetal calf serum at 37° C. in a 5% CO2 atmosphere. Cells should be mycoplasma-free for reproducible results. Usually 1-100 μL of the reconstituted extracts described in Example 1 are added to the cultures of the indicator cells (preferably seeded at densities of 25,000-200,000 cells in 0.2-1 mL medium in 24 well culture plates). Culture supernatants and/or cells are preferably harvested at 12-24 h post addition of the extracts to be tested.

Cytokine/Chemokine Assays.

The release of several chemokines and/or cytokines into the cell culture media due to addition of ATIs/ATI extracts to the above cells can be quantified to serve as a quantitative measure of stimulatory ATI activity. Examples are IL-8, IL-15, TNFa, CCL2 (MCP-1), CCL5 (RANTES). This can be done using commercial validated ELISAs (e.g. IL-8 and TNFa [BD]; MCP-1, IL-15, RANTES [R&D Systems]) according to the manufacturers' protocols. Apart from TLR4-dependent cytokines and chemokines, other secreted or cell extractable proteins/peptides downstream of TLR4 activation can be measured, including heat shock proteins (such as Hsp27, Hsp70, Hsp90) activation or known from the literature.

Use of Cells Transfected with TLR4-MD2-CD14 and an Indicator Gene

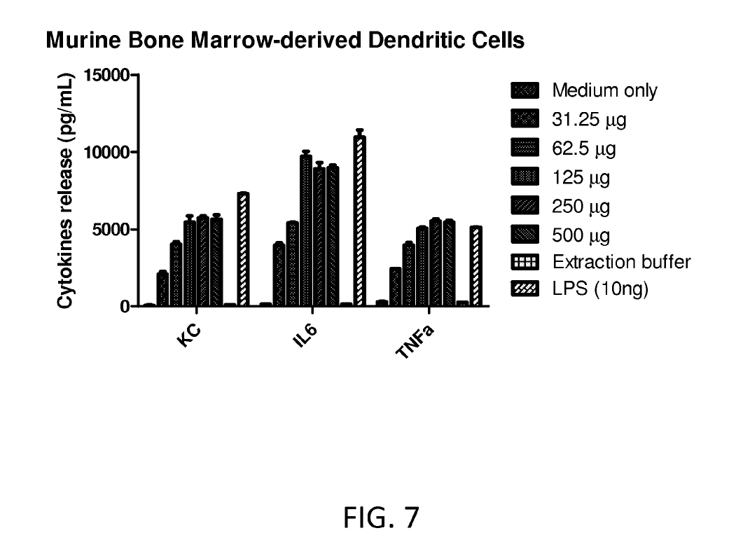

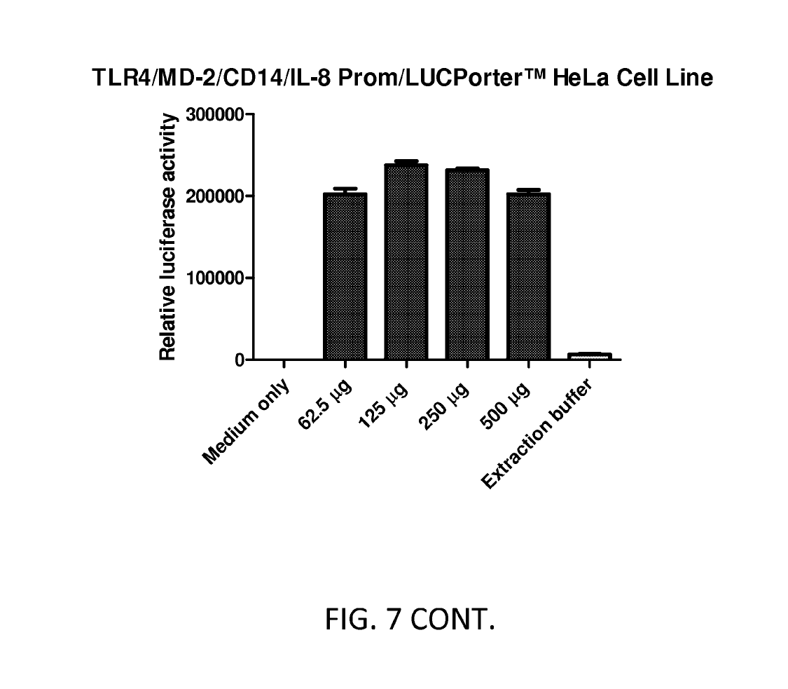

The lipopolysaccharide (LPS) receptor complex of TLR4, MD-2 and CD14 has been identified ATI-sensing receptor complex (Junker et al, J Exp Med 2012). Since IL-8 is a major cytokine induced by TLR4, a reporter cell line which stably expresses TLR4, MD-2 and CD14 proteins and the Renilla luciferase reporter gene under the transcriptional control of the IL-8 promoter was developed and is commercially available (R&D Systems, San Diego, Calif.; Lee et al 2013). We used this cell line to test ATI activity and compared values to those obtained with IL-8, MCP-1 and TNF-α release from ATI-stimulated THP-1 cells (FIG. 7). Other indicator systems that, e.g., generate fluorescent products or release soluble products that can be quantified in the cellular supernatant as described in Example 1, or harbor other promoters that are driven by the activation of the TLR4-MD2-CD14 can also be used. These systems are particularly well suited for high throughput or high quantitative measurements of TLR4-complex stimulating ATI-activity.

Other Assays for Determination of ATI Bioactivity

RNA Isolation and Quantitative RT-PCR

Total RNA is isolated from cells using e.g. TRIzol (Invitrogen). Quantitative RT-PCR is preferably performed using exon-exon boundary-spanning primer sequences and e.g., the SYBR green or Taqman methodology as described for a set of cytokines by Junker et al (2012). Apart from TLR4-dependent cytokines and chemokines, other transcripts downstream of TLR4 activation can be measured, including heat shock proteins (such as Hsp27, Hsp70, Hsp90) but also other transcriptionally activated genes known from the literature.

Flow Cytometry

After stimulation with extracted ATIs the above cells can also analyzed using flow cytometry that quantifies activation markers. Activation markers are e.g. CD80, CD86, MHC class II, IL-12, IL-23, interferon gamma (intracellular stain) and many others known from the common literature. Cells are preincubated with FcR blocking reagent (Miltenyi Biotec) for 15 min at 4° C. before staining preferably with fluorescent-labeled monoclonal antibodies to these activation markers at predetermined concentrations for e.g. 30 min at 4° C. Cells are then washed with staining buffer (e.g. PBS and 1% BSA), cell viability is assessed by DAPI exclusion (0.1 μg/ml; Roche), and only viable cells are analyzed by flow cytometry using e.g. a four-laser LSRII and FlowJo software (Tree Star) as described (Junker et al, J Exp Med 2012).

Altered Signal Transduction

Other quantitative readouts that can be used to measure ATI activity in samples are based on activation (or inhibition) of signaling pathways in the responsive cells. Examples are the phosphorylation of certain kinase substrates, such as IRF-3 or NFkB (p65), or NFkB nuclear translocation.

Lymphocyte Proliferation Assay

This method exploits the ability of TLR4-complex stimulated antigen presenting cells (such as monocytes, macrophages, dendritic or B cells) to permit proliferation or activation of antigen specific T cells in the presence of antigen. An example is the incubation of ovalbumin or gluten specific T cell lines or T cell clones, and HLA-compatible antigen presenting cells or cell lines loaded with ovalbumin (ova peptide) or gluten (gluten peptide), respectively. An (unknown amount of) ATI added to these cultures will dose-dependently stimulate T cell proliferation which can be measured in standard T cell proliferation assays, using e.g. 3H-thymidine or BrdU incorporation. A simplified version of such assay is the addition of ATI-containing solutions to a classical mixed lymphocyter reaction with white blood cells of peripheral human or non-human, e.g. rodent, blood, or e.g., rodent splenocytes.

### Example 2

### Methods to Determine the Chemical Quantity of ATIs in Unprocessed and Processed Foods

2.2 Quantitative Extraction of ATIs from Food

These methods permit another, even more thorough extraction of the highly proteolytically resistant ATIs (this resistance is mainly due to the presence of usually 5 intramolecular disulfide bridges), especially from processed, e.g., baked foods. Chemical quantification after reductive extraction is quantitative, but leads to loss of bioactivity due to unfolding of the proteins. However, this does not affect protein quantification. Extraction preferably uses reductive methods with or without detergents, and with or without additional proteolytic digestion.

These methods permit quantification of all ATI-species in a given cereal variant. Thus whole wheat genome sequencing revealed that modern hexaploid wheat contains up to 16 different ATI-species, and about half of these have been characterized as proteins. Moreover, ATIs represent between 2% and 4% of total wheat protein (with 80%-90% being gluten proteins). Importantly, ancient and older (diploid, tertraploid and early hexaploid) wheats contain fewer ATI genes and proteins (Altenbach et al, BMC Res Notes 2011; Dupont et al, Proteome Sci 2011). Finally, a second fertilization cycle (post anthesis fertilization) increases total protein content (mainly gluten), but decreases ATI content (Altenbach et al., Proteome Sci 2011). This is reflected by our bioactivity determinations shown below. We also show that the various ATI-variants display similar TLR4-stimulating bioactivity on a molar basis (see below).

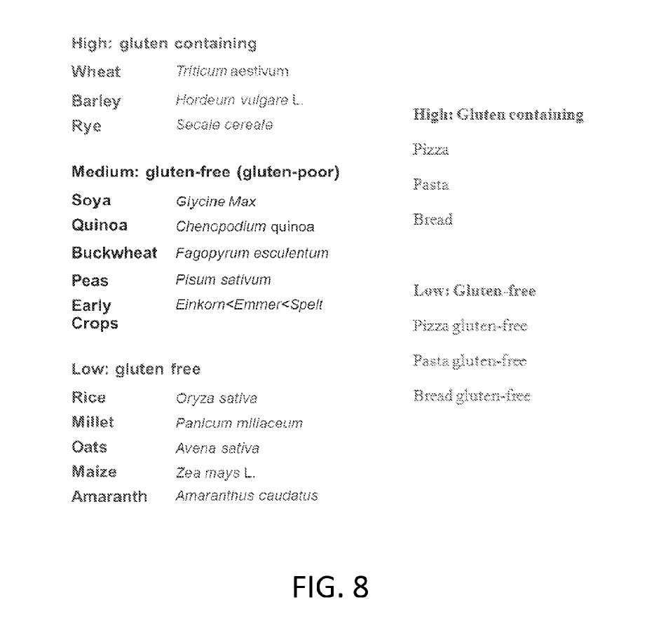

Importantly, the other major gluten containing cereals (barley and rye) express various amylase/trypsin/chymotrypsin/subtilisin inhibitors with high sequence homology to the wheat ATIs (Pekkarinen et al, J Agricult Food Chem 2003; Junker et al, J Exp Med 2012) and with similar overall TLR4-stimulating bioactivity (FIG. 8).

### Example

### Reductive Extraction of ATIs

One gram of the (dried) food to be analyzed is extracted in neutral, near neutral or alkaline solvents/buffers, such as PBS, Tris-buffer, ammonium bicarbonate, preferably containing a detergent or detergent mixture (e.g., sodiumdodecyl sulfate, Triton X-100, Tween-20, sodium deoxycholate), and a reducing agent, such as 2-mercapto-ethanol, dithioerythritol (DTT), e.g. at 5-200 mM and at 37° C. for 30 min to 4 hrs. For stabilization of free thiol groups, samples should be alkylated, e.g., with iodoacetamide at a final concentration of 20-500 mM for 10-60 min in the dark. Iodoacetamide will be quenched by excess reducing agents, e.g., 200 mM DTT. The cleared supernatant can be separated from small molecular weight contaminants e.g. by dialysis or ultrafiltration. For mass spectrometry the suspension (cleared supernatant) can be further digested, e.g., with trypsin.

For further analysis samples can be freeze-dried, concentrated in solution, e.g., by ultracentrifugation, or protein can be adsorbed to a solid support. For mass spectrometry, peptides are preferably adsorbed to a solid support.

### 2.2 Quantification of Extracted ATIs

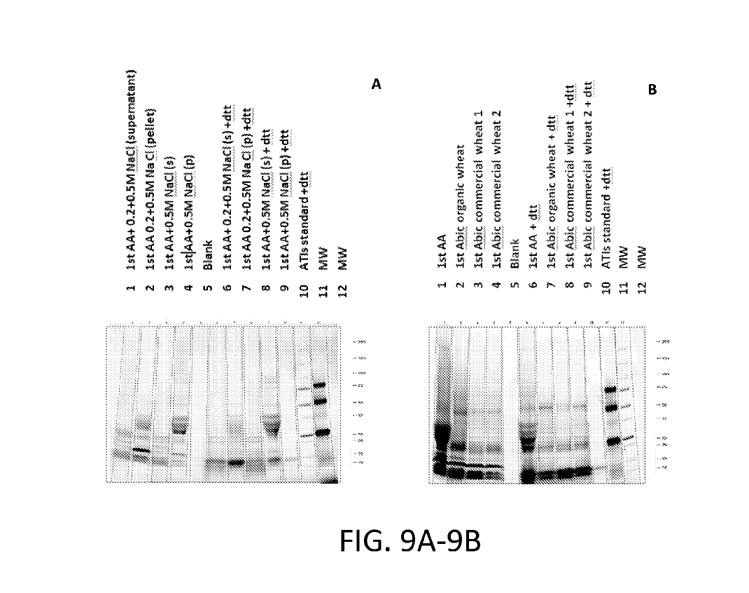

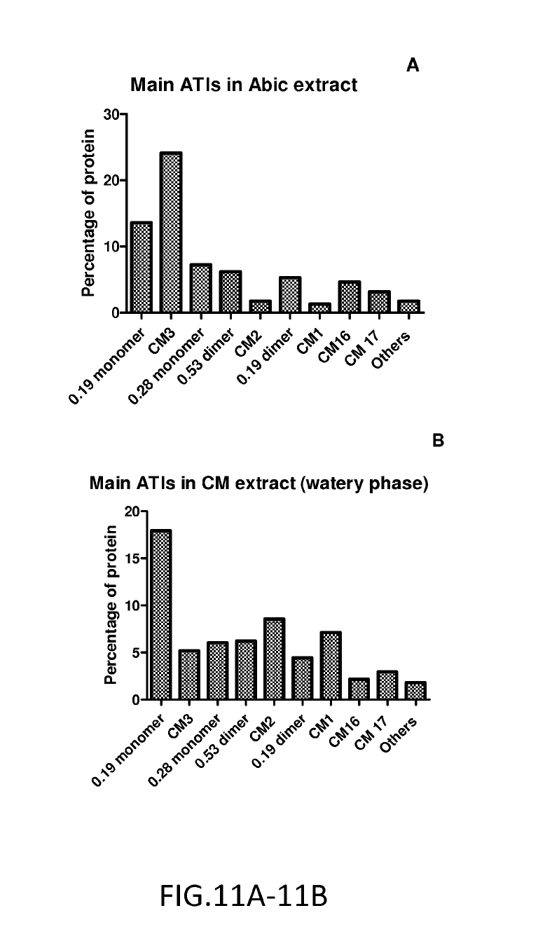

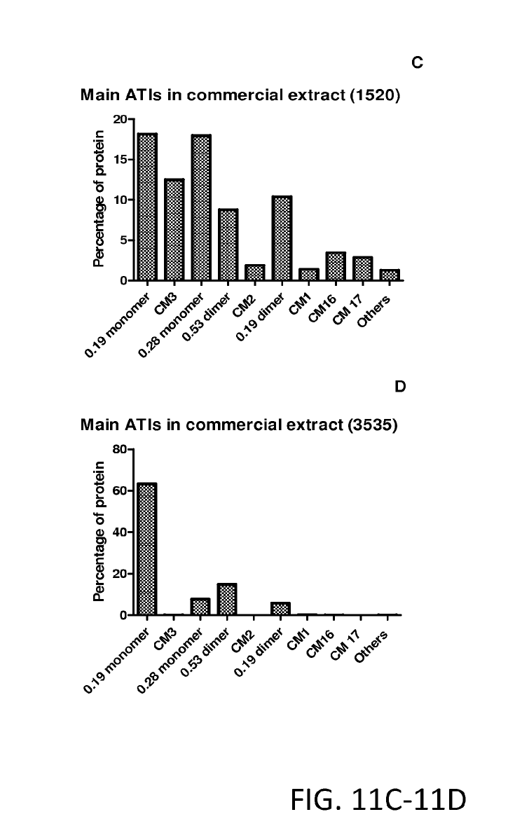

Examples of chemical quantification of ATIs in flours are shown in FIGS. 9-12.

Mass Spectrometry

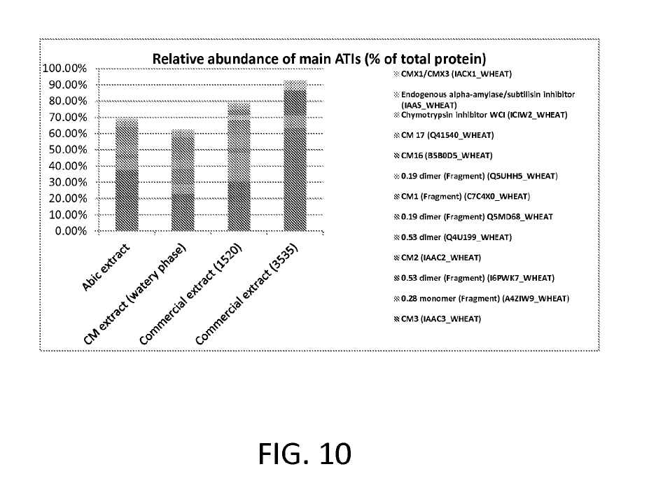

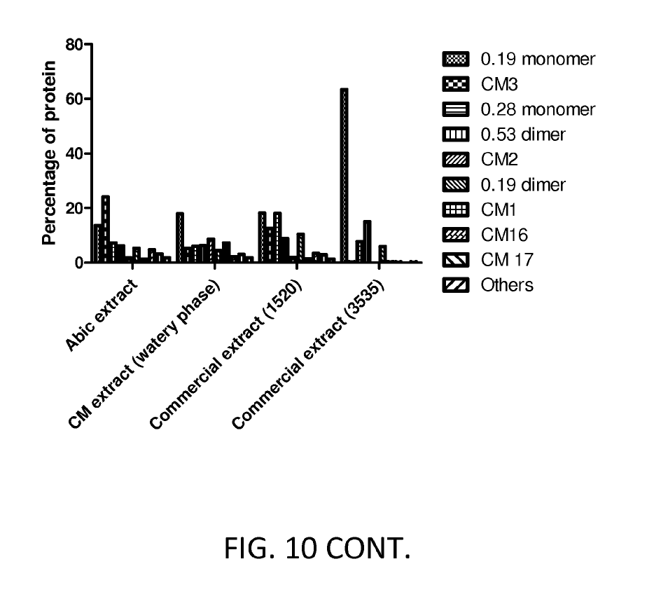

This is preferentially performed in samples enriched in ATIs (quantitative extraction) and performed after proteolytic digest, using standard state of the art quantitatative MS techniques (Prandi B et al, Food Chem 2013). Liquid chromatography-mass spectrometry quantification of 4 different ATI isolates is shown in FIGS. 10-12.

Quantitative Western Blotting

This is performed after reconstitution in appropriate buffers and by using poly- or monoclonal antibodies directed either to total ATIs or to all or major ATI species. This works best without proteolytic digest.

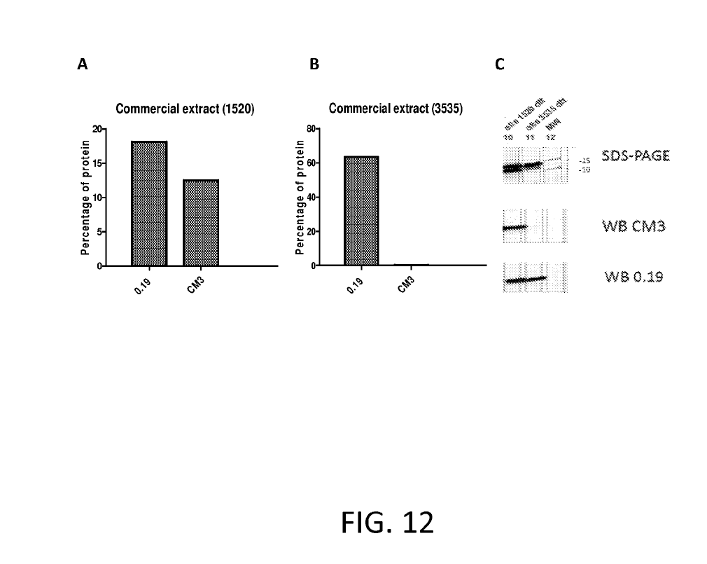

High titer antibodies have been produced against a mixture of ATIs extracted from hexaploid wheat and against several antigenic epitopes of major ATIs such as CM3, CM16, 0.19 or 0.54. Examples of Western blot characterization are shown in FIG. 12C.

Up to 16 ATI species have been described in what based on genetic analysis. However, a subset of ATIs usually represent >90% of all ATIs. These are noncovalently linked tetrameric CM2, CM3, CM16, dimeric 0.19, 0.54, and monomers of e.g. 0.19 and 0.54 (Altenbach et al, BMC Res Notes 2011; Dupont et al, Proteome Sci 2011). Our data indicate that TLR4-stimulatory ability as highest for di- and tetrameric ATIs and lowest for monomeric ATIs. Quantification of the major 3-8 ATI species in a given wheat, rye, or barley variant will approximate total ATI quantification. If desired, also the minor species can be quantified.

ELISA or Similar Quantitative Assays

These work best both without and with (limited) proteolytic digest. They are based on monoclonal or polyclonal antibodies produced against antigenic (linear as well as structural epitopes of the major ATIs). In ELISA one of the antibodies is bound to a solid phase, the other is linked to a detection system, such as biotin, alkaline phosphatase, peroxidase, fluorescent, or luminescent indicators, and state-of the art detection systems. This also includes assays based on inhibition which require, e.g., a coated antibody and a labeled ATI standard to compete with ATIs in the unknown sample. Other state of the art assays such as radioimmunoassays (equilibrium or inhibition format) or bead assays can also be used, including quantification by multiplexed assays.

### Example 3

### Methods to Prevent Correct Intramolecular Disulfide Formation in ATIs During Grain Growth or Filling

The equilibrium between oxidized glutathione (GSSG) and protein bound glutathione (PSSG) shifts towards PSSG during the grain filling phase, e.g., the accumulation of storage proteins, mainly gluten (Bykova et al., Phytochem 2011; Ferreira et al, Plant Physiol Biochem 2012), prevents premature intra- and intermoleular disulfide bonding. Fixing the growing wheat plant in this redox state, characterized by PSSG will also prevent disulfide bonding within ATI molecules, and thus make the ATIs highly susceptible to denaturation and proteolytic degradation, either before or after further processing of the wheat flour. Similarly, excessive and continuous induction of the plant's early developmental thioredoxin enzymatic system, also in conjunction with enhancement of PSSG complex formation, will keep nascent ATI molecules in the non-disulfide linked state, making them susceptible to proteolytic digestion (Wong et al, Phytochem 2004; Wong et al, Plant Cell Physiol 2004). These measures will also make wheat (rye, baley) flour more susceptible to proteolytic digestion in the human body.

Methods to promote the formation of PSSG bonds are cultivation with excess GSH or GSSG, the cultivation with or induction of enzymes that decrease the plant's redox potential such as superoxide dismutase or catalase activities. An alternative strategy is modulation of sulphur supply to the growing wheat (rye, barley), e.g., via use of sulphur rich vs. sulphur depleted fertilizers, also in sequence. Thus under sulphur depletion, resultant flour proteins including ATIs are more fixed in their disulfide structures and less susceptible to proteolytic degradation by external proteases or proteases if the gastrointestinal tract (Reinbold et al, J Agricult Food Chem 2008), although ATI content is (slightly) decreased.

### Example 4

### Methods to Remove ATIs or Abolish ATI Bioactivity from Complex Foods by Thorough Extraction from, e.g., Wheat (Rye, Barley, or by Fermentation and their Ancestral Grains) Prior to Introduction into the Food Chain

ATIs are quite resistant to degradation by many known proteases, including digestive enzymes of the human gastrointestinal tract such as pepsin, trypsin and chymotrypsin. Much of this resistance is due to the presence of several, usually five, intramolecular disulfide bonds that generate a compact secondary structure which is usually composed of four major alpha helices which are arranged up-and-down, securing a compact structure and hydrophobic interaction surfaces for di- and tetramerization (Oda et al, Biochemistry 1997). Useful methods to significantly decrease (>70%, preferably 80% and more) bioactive ATIs in e.g., flours are therefore based on 1) exhaustive extraction using preferably water based buffers, and 2) disulfide reduction which facilitates unfolding, eliminate bioactivity (i.e., activation of the TLR4-complex) and permit proteolytic digestion either before or during ingestion of the thus prepared foods. Proteolytic digestion of the reduced and unfolded ATIs can be achieved easily with common proteases used in the food industry, including e.g., pepsin at acidic pH, or e.g. trypsin, chymotrypsin or subtilisin at near neutral or alkaline pH. Enzymes that degrade unfolded or denatured ATIs are also produced during certain fermentation processes, as described below, including sourdough fermentation or reductive fermentation. This also includes fermentations that produce specific enzyme activities to cleave (unfolded, denatured) ATIs, including bacteria that have been engineered to produce such activity for the food industry.

4.1 Chemical Methods (See also FIGS. 5, 6, and 9)

Solvent Extraction of ATIs

ATIs can be extracted from flours and even processed foods using the methods described above (1.1.1 and 1.1.2). Extraction with water-based buffers is preferable due to low costs and lack of potential toxicity of residual solvent. The extracted flour (food) can be separated mechanically, e.g., by sedimentation or centrifugation, and then freeze-dried or (preferably) dried in air or other (inert) gases that permit drying of bulk quantities. Before drying the pellet, other steps, such as washes with water and/or with (organic) solvents that have a lower boiling point than water but bind residual water, such as acetone, ethanol, or similar solvents used in the food industry can be used for removal of traces of salt or acid (from the extraction buffer), and residual water. Residual water can also be retained when the extracted flour is frozen for storage and transport, or directly used for further food processing, such as fermentation or dough preparation.

Removal of 80-90% of bioactive ATIs can be reached with 1-2 extractions, as detailed in Example 1. This reduction would highly significantly reduce the risk of ATI-induced inflammation in the intestine and outside of the intestine in predisposed individuals, since nutritional ATI effects are dose dependent.

Chemical Reduction of Disulfides in ATIs.

These methods are similar to those detailed for analytical (quantitative) extraction of ATIs (described above). However, here the major aim is reductive inactivation of biologically active ATIs, in order to eliminate their TLR4 stimulatory activity, without toxicity to the consumer.

### Example

### Reductive Inactivation of ATIs

100 g of the (dried) flour or food is incubated in neutral, near neutral, or alkaline solvents/buffers, such as water or saline with pH adjustment, or with PBS and a reducing agent, such as cysteine, or glutathione (GSH) balanced with oxidized glutathione (GSSG), at temperatures that can range between 4° C. and 100° C., for times that can range between one second and 24 hrs. Other usually mildly reducing agents that are known in the food industry can also be used. Reduced ATIs are preferably denatured at temperatures above 50° C. and can be locked in this denatured state by disulfide linkage with, e.g., cysteine or GSH, or via mis-folded, newly generated, intra- and intermolecular disulfide bonds. Other free SH-group blocking agents used in the food industry can also be employed.

Fixation of partly reduced and thus severed intramolecular disulfides in ATIs can also be brought about during dough mixing by the addition of vitamin C or other pro-oxidative systems that generate, e.g., activated oxygen. This has been demonstrated for disulfides in glutenins (Koehler P et al, J Agricult Food Chem 2003a and b), but is also effective in ATIs.

### 4.2 Fermentation Strategies to Decrease Bioactive ATI in Foods Such as Flours

There are several fermentation methods that reduce ATI bioactivity, largely being based on non-reductive or reductive fermentation and/or proteolytic digestion of (disulfide reduced) ATIs.

Fermentation of wheat (rye, barley) dough with lactobacilli is used to enhance the degradation of gluten proteins under acidic conditions. Select lactobacilli that have an active thiol (disulfide reducing) metabolism are particularly suited to reduce and subsequently degrade ATIs proteolytically. An example are Lactobacillus reuteri and L. sanfranciscensis which efficiently deactivate proteins such as the highly disulfide linked ovotransferrin of wheat as well as ATIs. Proteolytic activity is mainly brought about by wheat aspartic acid proteases (Loponen et al, J Agricult Food Chem 2007; Loponen et al, J Agricult Food Chem 2008), but other proteolytic enzymes used in the food industry can be added. Fermentation of wheat flour and other ATI-containing flours can be done e.g. with varying proportions of rye malt in the dough, such as 5-20%. Here, apart from adding beneficial bacteria that are used in the food industry to prepare e.g. sourdough (Lactobacillus species), rye malt serves as source of proteolytic enzymes that were shown to degrade immunogenic gluten proteins (Loponen et al, J Agricult Food Chem 2007). This method can be combined with any of the other ATI-reducing methods described herein.

Reduction of ATI Content by Non-Reductive and Reductive Fermentation of ATI-Containing Flours and Doughs

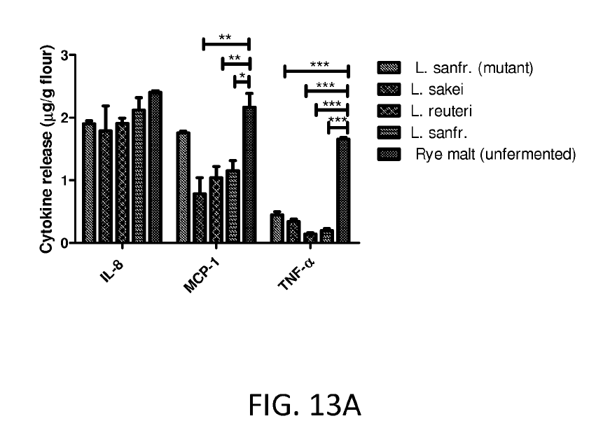

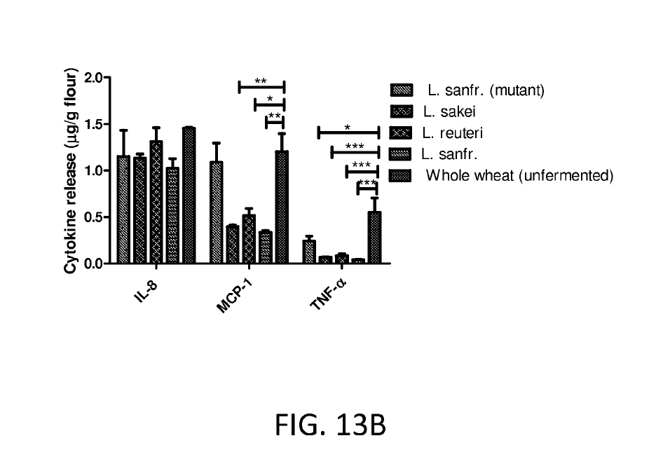

The doughs can be prepared with whole wheat flour and without additives. Optimization is possible using refined instead of crude flours, or addition of common agents that are used in the food industry to improve fermentation or dough quality. An example is the addition of reducing agents, such as cysteine or glutathione, either before, during or after fermentation. Another alternative is the use of fermenting bacteria with high disulfide reducing ability. Such strains have been described and comprise, e.g., Lactobacillus sanfranciscensis and L. reuteri LTH2584 FIG. 13 shows the results of fermentation experiments (24 hrs) performed. ATI activity was determined in two sequential combined ammonium bicarbonate extractions from the fermented and then frozen doughs, using the methodology described above.

The following fermentation protocols were applied for 24 hrs at 37° C.:
i) chemically acidified control (low SH (sulfhydryl)-levels in dough, no reduction of disulfide bonds in proteins);
ii) Lactobacillus sakei (low SH);
iii) Lactobacillus sanfranciscensis (high SH-levels in dough and reduction of disulfide bonds in proteins owing to glutahione reductase activity);
iv) Lactobacillus sanfranciscensis delta gsrH (low SH-levels in dough as gene coding for glutathione reductase gene was disrupted);
v) Lactobacillus reuteri LTH2584 (high SH-levels owing to cystathionine gamma lyase);
vi) a second chemically acidified control to match the growth temperature of L. reuteri.

Controls for appropriate fermentation: Doughs were analysed with respect to pH, organic acid levels and SH-groups, as were the numbers of fermenting bacteria. The data demonstrate an up to ˜50-60% reduction in ATI-bioactivity in the sourdoughs that were fermented with Lactobacilli in general, either with or without rye malt addition. This indicates significant proteolytic digestion and thus inactivation of ATIs by fermentation in general, without higher degradation activity by disulfide reducing strains.

Notably, an advantage of the thiol-reducing bacteria (L. sanfranciscensis and L. reuteri) is likely. In a preliminary experiment, post fermentation heating of the dough to elevated temperatures that do not yet inactivate the rye (barley) malt or Lactobacillus-derived proteolytic enzymes (time up to 2 hrs) could further reduce ATI bioactivity down to 20% in the doughs subject to thiol reducing Lactobacilli vs. 30% in the non-thiol-reducing bacteria, indicating an advantage of the former strains. This was accompanied by a comparable reduction of major ATI-bands CM3 and 0.19 in a Western blot using our polyclonal antibodies specific for these protein. Overall, reductive fermentation more than conventional fermentation leads to disulfide reduction of ATIs which then become susceptible to proteolytic degradation by enzymes used in the food industry, such as those produced by Lactobacillae or that are present in malt.

### Example 5

### TLR4 Antagonistic Compounds that can be Added to ATI Containing Foods

There are several (weak to moderately active) oral TLR4 antagonists, many of them of herbal origin, with long-term use as spices or food additives. These are e.g. alkaloids, aromatic compounds, polyphenols, peptides or proteins (Rossignal and Lynn 2005; Lucas and Maes, Mol Neurobiol 2013). Examples include, but are not limited to, Bartonella quintana lipopolysaccharide (Popa et al, Infect Immunol 2007); extracts of leaves from Clerodendrum (Kouakou et al, BMC Complement Altern Med 2013); cinnamon extract and its active components (Kanuri et al, J Nutr 2009); eritoran mimicking the MD component of the TLR4-MD2-CD14 complex, formulated to be resistant to gastric or intestinal hydrolysis (Shirey et al, Nature 2013); epigallocatechin-3-gallate from, e.g., green tea (Hong et al, J Immunol 2010; Bao et al, Mol Nutr Food Res 2013); 6-shogaol and 1-dehydro-10-gingerdione (1D10G) from Ginger (Ahn et al, Mol Cless 2009; Park et al, Biochem Biophys Res Communic 2012); Melatonin (Hu et al, Pinela Res 2013); Berberin as TLR4-NFkB pathway inhibitor (Li et al, Acta Pharmacol Sin 2012); Lipopolysaccharide from the photosynthetic bacterium Rhodobacter sphaeroides (LPS-RS) (Rallabhandi et al, Coats et al, J Immunol 2005); and Lipopolysaccharide from Porphyromonas gingivalis (Coats et al, J Immunol 2005; Curtis et al, Infect Immunol 2011)

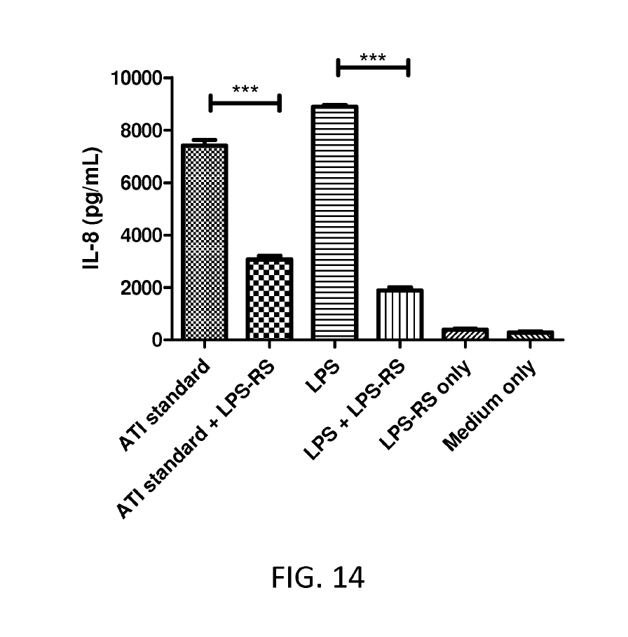

Adding these compounds or compound mixtures with proven TLR4 antagonistic activity to ATI-containing foods will antagonize the TLR4-activating activity of ATIs, without need of prior extraction or inactivation. This should be relevant to either completely avoid these prior inactivation or extraction steps, or to “neutralize” residual ATI activity after these steps. We could demonstrate that this neutralization of ATI-induced innate immune activation by using the natural TLR4-antagonist from the photosynthetic bacterium Rhodobacter sphaeroides (LPS-RS) (Rallabhandi et al, J Immunol 2005) (FIG. 14).

### Other Embodiments

All publications, patents, and patent applications mentioned in the above specification are hereby incorporated by reference to the same extent as if each individual publication, patent or patent application was specifically and individually indicated to be incorporated by reference in its entirety. Various modifications and variations of the described devices and methods of the invention will be apparent to those skilled in the art without departing from the scope and spirit of the invention. Although the invention has been described in connection with specific embodiments, it will be understood that it is capable of further modifications and that the invention as claimed should not be unduly limited to such specific embodiments. Indeed, various modifications of the described modes for carrying out the invention that are obvious to those skilled in the art are intended to be within the scope of the invention. This application is intended to cover any variations, uses, or adaptations of the invention following, in general, the principles of the invention and including such departures from the present disclosure come within known customary practice within the art to which the invention pertains and may be applied to the essential features herein before set forth.

Other embodiments are within the following claims.

1. A method of reducing the ATI content of a foodstuff, said method comprising incubating said foodstuff in an extraction buffer for a duration sufficient to reduce the ATI content of said foodstuff by at least 50% followed by removing said extraction buffer from said foodstuff.

2. The method of claim 1, wherein said extraction buffer is a neutral, near neutral, or alkaline solvent or buffer.

3. The method of claim 2, wherein said extract buffer is selected from the group consisting of PBS, Tris-buffer, water, and ammonium bicarbonate.

4. The method of claim 2 or 3, wherein said extract buffer further comprises a detergent or detergent mixture.

5. The method of claim 4, wherein said detergent or detergent mixture is selected from the group consisting of sodiumdodecyl sulfate, Triton X-100, Tween-20, sodium deoxycholate.

6. The method of any one of claims 1-5, wherein said extraction buffer further comprises a reducing agent.

7. The method of claim 6, wherein said reducing agent is selected from the group consisting of mercapto-ethanol, dithioerythritol (DTT), cysteine, or glutathione (GSH) balanced with oxidized glutathione (GSSG).

8. The method of any one of claims 1-7, wherein said alkylating agent is iodoacetamide and said alkylating agent is further quenched by the addition of access reducing agent.

9. The method of any one of claims 1-8, wherein said foodstuff is separated mechanically prior to said incubation.

10. The method of claim 9, wherein said mechanically separated foodstuff is dried prior to said incubation.

11. The method of claim 10, wherein said drying is air-drying or freeze drying.

12. The method of claim 10 or 11, wherein, prior to said drying, said mechanically separated foodstuff is contacted with an aqueous solvent or an organic solvent having a lower boiling point than water.

13. The method of claim 12, wherein said organic solvent is selected from the group consisting of acetone or ethanol.

14. A method of extracting amylase trypsin inhibitors (ATIs) from a foodstuff, said method comprising:
A. incubating said foodstuff with an extraction buffer in a mixture;
B. centrifuging said mixture to form a pellet and supernatant;
C. drying said supernatant; and
D. reconstituting the dried supernatant in a reconstitution buffer;
wherein extracted ATIs are present in said reconstitution buffer.

15. The method of claim 14, wherein said foodstuff is unprocessed prior to extraction.

16. The method of claim 14, wherein said foodstuff is a processed foodstuff.

17. The method of any of claims 14-16, wherein, prior to step A, said foodstuff is ground.

18. The method of any of claims 14-17, wherein, prior to step A, said foodstuff is defatted.

19. The method of claim 18, wherein said defatting is performed by the incubation of said foodstuff with methanol/diethylether.

20. The method of claim 19, wherein said methanol/diethyl ether is present at a 1:1 ratio.

21. The method of any of claims 1-20, wherein said extraction buffer is ammonium bicarbonate, chloroform/methanol, or an acid.

22. The method of claim 21, wherein said acid is acetic acid.

23. The method of claim 21 or 22, wherein said extraction buffer is at a concentration between 5 mMol to 100 mMol.

24. The method of any of claims 14-23, wherein said drying is freeze-drying or drying under a stream of gas, e.g., air.

25. The method of any of claims 14-24, wherein steps A-C are repeated prior to step D.

26. The method of claim 25, wherein the extraction buffer in steps A-C is first chloroform/methanol and the extraction buffer is ammonium bicarbonate when steps A-C are repeated or wherein the extraction buffer is ammonium bicarbonate in both extractions.

27. The method of any of claims 14-26, wherein, prior to step A, the foodstuff is digested with a protease.

28. The method of claim 27, wherein said protease is pepsin, trypsin, chymotrypsin, and/or thermolysin.

29. The method of claim 28, wherein said foodstuff is first digested with pepsin followed by digestion with trypsin.

30. The method of any of claims 27-29, wherein, after the foodstuff is digested with a protease, the foodstuff is centrifuged to form a supernatant and said supernatant is incubated with the extraction buffer of step A.

31. The method of claim 30, wherein said incubation is performed as a dialysis incubation, step B is omitted, and said supernatant, after dialysis is dried in step C.

32. A method of determining the bioactivity of ATIs in a sample, said method comprising incubating ATI-reactive cells with an extract suspected of comprising ATIs and determining an ATI-response in said ATI-reactive cells, thereby determining the bioactivity of said ATIs in a sample.

33. The method of claim 32, wherein said extract suspected of comprising ATIs is prepared by the method of any one of claims 1-18.

34. The method of claim 32 or 33, wherein said ATI-reactive cells express TLR4.

35. The method of any one of claims 32-34, wherein said ATI-reactive cells are selected from the group consisting of monocytes/macrophages, dendritic cells, or cells transfected with a TLR4-MD2-CD14 oligomeric signaling complex.

36. The method of claim 35, wherein said cells are stable cell lines selected from the group consisting of THP-1 and U937 cells.

37. The method of any of claims 32-36, wherein said determination of ATI-response comprises quantification of one or more cytokines released by said cells.

38. The method of claim 37, wherein said one or more cytokines are selected from the group consisting of IL-8, IL-15, TNFα, CCL2 (MCP-1), and CCL5 (RANTES).

39. The method of claim 37 or 38, wherein said quantification is performed by ELISA.

40. The method of any one of claims 32-36, wherein said cell comprises a reporter gene under the control of a TLR4 (ATI)-responsive promoter and said determination of an ATI-response comprises detection of expression of said reporter gene.

41. The method of claim 40, wherein said ATI-responsive promoter is the IL-8 promoter.

42. The method of claim 40 or 41, wherein said reporter gene encodes a luminescent or fluorescent protein.

43. The method of any one of claims 32-36, wherein said determination of ATI-response comprises measuring a level of one or more RNAs in said cells associated with an ATI-response.

44. The method of claim 43, wherein said one or more RNAs corresponds to Hsp27, Hsp70, and/or Hsp90.

45. The method of any one of claims 32-36, wherein said determination of ATI-response comprises detecting one or more activation markers on or in said cells.

46. The method of claim 45, wherein said one or more activation markers is selected from the group consisting of CD80, CD86, MHC class II, IL-12, IL-23, and interferon gamma (release or intracellular stain).

47. The method of claim 45 or 46, wherein said detecting comprises flow-cytometry.

48. The method of any one of claims 32-36, wherein said determination of ATI-response comprises detecting an alteration is a signaling pathway associated with an ATI response.

49. The method of claim 48, wherein said alteration in a signaling pathway is detected based on the detection of IRF-3, NFkB (p65), or NFkB nuclear translocation.

50. The method of any one of claims 32-36, wherein said determination of ATI-response comprises contacting ovalbumin or gluten specific T cells in the presence of said sample suspected of containing ATIs and measuring the proliferation of said cells in the presence of ATI-reactive antigen presenting cells.

51. A method of quantifying the amount of ATIs in a foodstuff, said method comprising:
incubating said foodstuff in an extraction buffer thereby forming an extract;
optionally incubating said extract with an alkylating agent;
separating the ATIs from said extract; and
quantifying said separated ATIs.

52. The method of claim 51, wherein said extraction buffer is a neutral, near neutral, or an alkaline solvent or buffer.

53. The method of claim 52, wherein said extract buffer is selected from the group consisting of PBS, Tris-buffer, ammonium bicarbonate.

54. The method of claim 52 or 53, wherein said extract buffer further comprises a detergent or detergent mixture.

55. The method of claim 54, wherein said detergent or detergent mixture is selected from the group consisting of sodium dodecyl sulfate, Triton X-100, Tween-20, sodium deoxycholate.

56. The method of any one of claims 51-55, wherein said extraction buffer further comprises a reducing agent.

57. The method of claim 56, wherein said reducing agent is selected from the group consisting of mercapto-ethanol or dithioerythritol (DTT).

58. The method of any one of claims 51-57, wherein said alkylating agent is iodoacetamide and said alkylating agent is further quenched by the addition of access reducing agent.

59. The method of any of claims 51-58, wherein said method further comprises adding a protease to said extract.

60. The method of claim 59, wherein said protease is trypsin.

61. The method of any of claims 51-60, wherein said ATIs are quantified by mass spectrometry, quantitative western blotting, or ELISA.

62. A method of reducing the reactivity of a foodstuff, said method comprising cultivating a cereal with oxidized glutathione (GSSG) and/or protein bound glutathione (PSSG).

63. A method of reducing the reactivity of a foodstuff, said method comprising cultivating a cereal with sulfur rich or sulfur depleted fertilizers.

64. A method of reducing the ATI content of a foodstuff, said method comprising fermenting said foodstuff with a bacteria with high disulfide reducing ability.

65. The method of claim 64, wherein said bacteria is selected from the group consisting of Lactobacillus sanfranciscensis and L. reuteri LTH2584.
